(19) United States
(12) Patent Application Publication
(10) Pub. No.: US 2015/0377453 A1
(43) Pub. Date: Dec. 31, 2015

(54) LIGHT EMITTING MODULE

(71) Applicant: SAMSUNG ELECTRONICS CO., LTD., Suwon-si (KR)

(72) Inventors: Won Soo JI, Hwaseong-si (KR); Tetsuo ARIYOSHI, Suwon-si (KR); Sang Woo HA, Seongnam-si (KR); Hae Chul KIM, Suwon-si (KR)

(21) Appl. No.: 14/622,711

(22) Filed: Feb. 13, 2015

(30) Foreign Application Priority Data
Jun. 27, 2014 (KR) 10-2014-0079918

(51) Int. Cl. F21V 13/04; F21V 8/00; F21V 23/00; F21K 99/00; F21V 23/04

(52) U.S. Cl. CPC F21V 13/04; F21K 9/50; F21V 23/0442; F21V 23/003; G02B 6/0075; F21Y 2105/001

(57) ABSTRACT

A light emitting module includes a light emitting unit including a plurality of light sources, a reflection unit disposed on the light emitting unit and configured to reflect light emitted from the light emitting unit, and a lens unit disposed on an optical path of the light reflected by the reflection unit. The reflection unit includes a plurality of reflection holes corresponding to the plurality of light sources and having inner walls which are provided as reflective surfaces. A depth of a reflection hole distant from an optical axis of the lens unit is greater than a depth of a reflection hole adjacent to the optical axis of the lens unit.

### CROSS-REFERENCE TO RELATED APPLICATION

This application claims priority under 35 U.S.C. §119 to Korean Patent Application No. 10-2014-0079918, filed on Jun. 27, 2014, with the Korean Intellectual Property Office, the entire disclosure of which is incorporated herein by reference.

### BACKGROUND

The present inventive concept relates to a light emitting module.

Semiconductor light emitting devices emit light through the recombination of electrons and holes when power is applied thereto, and are commonly used as light sources due to various advantages thereof such as low power consumption, high levels of luminance, compactness, and the like. In particular, after the development of nitride light emitting devices, the utilization thereof has been greatly expanded and nitride light emitting devices are employed as light sources in general lighting devices, headlights of vehicles, and the like. Meanwhile, a light emitting module using such semiconductor light emitting devices is generally provided with a lens, and thus a light distribution area of the light emitting module may not have a clearly-defined boundary due to physical properties of the lens such as spherical aberration or the like, and in particular, may be distorted at an edge portion thereof, resulting in a deterioration in the quality of light emitted from the light emitting module.

### SUMMARY

An aspect in the present inventive concept may provide a light emitting module producing light having excellent quality due to a reduction in spherical aberration of a lens.

An aspect in the present inventive concept may also provide a light emitting module applicable to a headlight of a vehicle, by which the division of a light distribution area may be controlled such that a particular area (e.g., an area in which the view of a driver of an oncoming vehicle is not obscured) is not irradiated with light.

According to an aspect in the present inventive concept, a light emitting module may include a light emitting unit including a plurality of light sources, a reflection unit disposed on the light emitting unit and configured to reflect light emitted from the light emitting unit, and a lens unit disposed on an optical path of the light reflected by the reflection unit. The reflection unit may include a plurality of reflection holes corresponding to the plurality of light sources and having inner walls which are provided as reflective surfaces. A depth of a reflection hole distant from an optical axis of the lens unit may be greater than a depth of a reflection hole adjacent to the optical axis of the lens unit.

Depths of the plurality of reflection holes may be increased as distances thereof from the optical axis of the lens unit in a direction perpendicular to the optical axis of the lens unit are increased.

The light emitting unit may include a board having a flat mounting surface perpendicular to the optical axis of the lens unit, and light emitting surfaces of the plurality of light sources may be disposed to be substantially equal level with each other based on the mounting surface of the board.

The plurality of reflection holes may include first openings adjacent to the light emitting unit and second openings adjacent to the lens unit, respectively, and distances of the second openings from the lens unit may be decreased as distances of the second openings from the optical axis of the lens unit in a direction perpendicular to the optical axis of the lens unit are increased.

The reflection unit may have a first surface on which the first openings are disposed and which is provided as a flat surface perpendicular to the optical axis of the lens unit, and a second surface on which the second openings are disposed and which is stepped.

The lens unit may have a focal plane of which the center on the optical axis is convex toward the reflection unit, and the second surface of the reflection unit may have a stepped portion which is concave with respect to the focal plane.

The second openings may have substantially the same size.

The inner walls may extend from the first openings to the second openings with a predetermined degree of inclination, and the degree of inclination may be increased as distances of the inner walls from the optical axis of the lens unit in the direction perpendicular to the optical axis are increased.

The depths of the plurality of reflection holes may be increased as distances thereof from the optical axis of the lens unit in at least one of the first and second directions are increased, wherein a first direction is perpendicular to the optical axis of the lens unit and a second direction is perpendicular to the optical axis and the first direction, and.

The reflection unit may include a plurality of reflective optical elements having reflective cups, respectively, and the plurality of reflection holes may be provided by using the reflective cups included in the reflective optical elements.

The light emitting module may further include a driving control unit configured to supply driving power to the plurality of light sources, wherein the plurality of light sources may be divided into first to n-th light source groups sequentially arranged in a direction perpendicular to the optical axis of the lens unit, where n is an integer equal to or greater than 2, and the driving control unit may be configured to control the first to n-th light source groups individually.

The light emitting module may further include a sensor unit configured to generate a sensing signal by detecting at least one of a position of an object and external light, wherein the driving control unit is configured to determine whether to drive the first to n-th light source groups according to the sensing signal generated by the sensor unit.

According to an aspect in the present inventive concept, a light emitting module may include a light emitting unit including a plurality of light sources; a plurality of light guides disposed to correspond to the plurality of light sources, respectively, each of which has a light incidence surface to which light emitted from a corresponding light source is incident and a light emitting surface from which the light incident through the light incidence surface is emitted; and a lens unit disposed on an optical path of the light emitted through the light emitting surfaces of the plurality of light guides. A distance between the lens unit and a light emitting surface of a light guide distant from an optical axis of the lens unit may be less than a distance between the lens unit and a light emitting surface of a light guide adjacent to the optical axis of the lens unit.

Distances between the lens unit and the light emitting surfaces of the plurality of light guides may be decreased as distances of the plurality of light guides from the optical axis of the lens unit in a direction perpendicular to the optical axis of the lens unit are increased.

Heights of the plurality of light guides may be increased as distances of the plurality of light guides from the optical axis of the lens unit in a direction perpendicular to the optical axis of the lens unit are increased.

According to an aspect in the present inventive concept, a light emitting module may include a lens unit having an optical axis, a plurality of light sources disposed spaced-apart from the lens unit, and a plurality of light confining units disposed between the plurality of light sources and the lens unit, each light confining unit corresponding to one of the plurality of light sources and guiding light emitted from the one of the plurality of light sources to the lens unit. A distance between the lens unit and a light confining unit distant from the optical axis of the lens unit may be less than a distance between the lens unit and a light confining unit adjacent to the optical axis of the lens unit.

The plurality of light sources may be disposed at a plane perpendicular to the optical axis of the lens unit.

Lengths of the light confining units may be increased as distances thereof from the optical axis of the lens unit in a direction perpendicular to the optical axis of the lens unit are increased.

Each light confining unit may include a hole confined by a reflective inner wall of the each light confining unit. The hole of the each light confining unit may extend from a corresponding light source of the each light confining unit toward the lens unit in a direction parallel to the optical axis of the lens unit. The plurality of light confining units may be integrally formed as a single element or formed as discrete elements.

Each light confining unit may include a core extending from a corresponding light source of the each light confining unit toward the lens unit in a direction parallel to the optical axis of the lens unit, and a cladding surrounding the core. The core and the cladding may have different refractive indexes.

### BRIEF DESCRIPTION OF DRAWINGS

The above and other aspects, features and advantages in the present inventive concept will be more clearly understood from the following detailed description taken in conjunction with the accompanying drawings, in which:

FIG. 1 is an exploded perspective view schematically illustrating a light emitting module according to an exemplary embodiment in the present inventive concept;

FIG. 2 is a cross-sectional view of FIG. 1, taken along line A-A′;

FIGS. 3A through 3C are conceptual views illustrating a principle of improving the quality of light emitted from a light emitting module according to an exemplary embodiment in the present inventive concept;

FIGS. 4A and 4B are photographs illustrating the effects of light emitting modules according to inventive and comparative examples;

FIG. 5 is a view illustrating a modified exemplary embodiment of FIG. 1, in which a light emitting unit and a reflection unit of the light emitting module are viewed from above;

FIG. 6 is a conceptual view illustrating an example of a headlight module to which a light emitting module according to an exemplary embodiment in the present inventive concept is applied;

FIGS. 7A and 7B are conceptual views illustrating the operations of the headlight module of FIG. 6;

FIG. 8 is a conceptual view illustrating divided driving control of the headlight module of FIG. 6;

FIGS. 9A and 9B are graphs illustrating comparative experimental results to illustrate the effect of the headlight module according to the exemplary embodiment of FIG. 6;

FIG. 10A is an exploded perspective view schematically illustrating a light emitting module according to an exemplary embodiment in the present inventive concept;

FIG. 10B is a cross-sectional view of FIG. 10A, taken along line B-B′;

FIG. 11 is a perspective view schematically illustrating a light emitting unit and a reflection unit applicable to a light emitting module according to an exemplary embodiment in the present inventive concept;

FIG. 12A is an exploded perspective view schematically illustrating a light emitting module according to an exemplary embodiment in the present inventive concept; and

FIG. 12B is a cross-sectional view of FIG. 12A, taken along line C-C′.

### DETAILED DESCRIPTION

Exemplary embodiments in the present inventive concept will now be described in detail with reference to the accompanying drawings.

The inventive concept may, however, be exemplified in many different forms and should not be construed as being limited to the specific embodiments set forth herein. Rather, these embodiments are provided so that this inventive concept will be thorough and complete, and will fully convey the scope of the inventive concept to those skilled in the art.

In the drawings, the shapes and dimensions of elements may be exaggerated for clarity, and the same reference numerals will be used throughout to designate the same or like elements

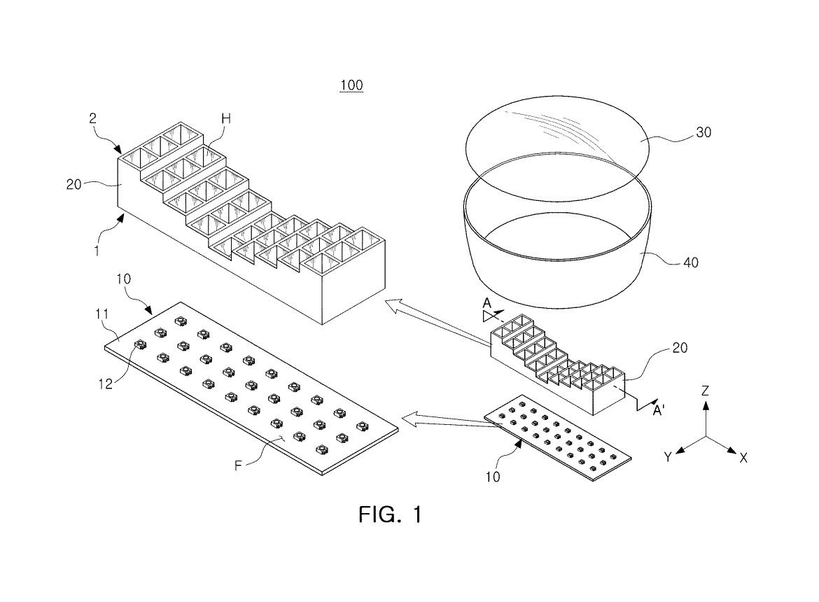

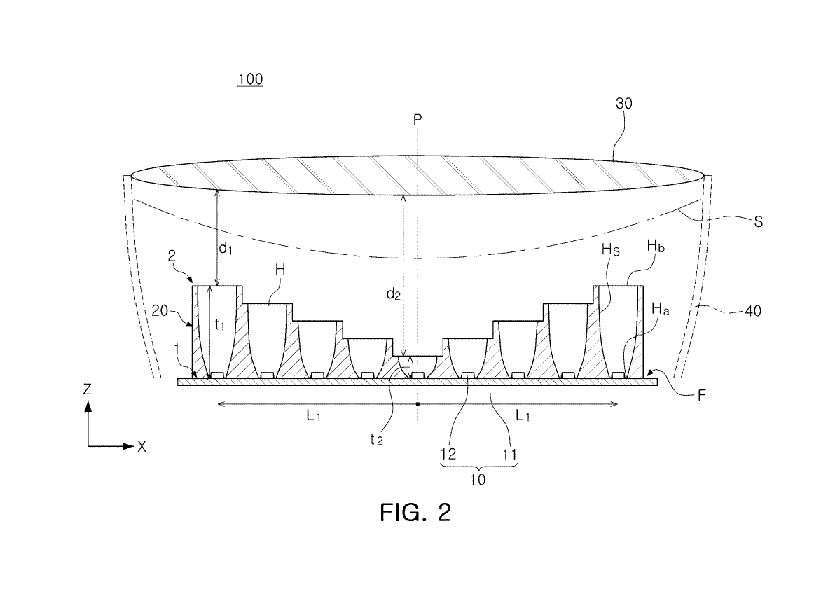

FIG. 1 is an exploded perspective view schematically illustrating a light emitting module 100 according to an exemplary embodiment in the present inventive concept, and FIG. 2 is a cross-sectional view of FIG. 1, taken along line A-A′. For a more detailed understanding, a housing 40 included in the light emitting module 100 illustrated in FIG. 1 is indicated by a dotted line in FIG. 2.

Referring to FIGS. 1 and 2, the light emitting module 100 according to the present exemplary embodiment may include a light emitting unit 10 having a plurality of light sources 12, a reflection unit 20 disposed on the light emitting unit 10 and reflecting light emitted from the light emitting unit 10, and a lens unit 30.

The lens unit 30 may be disposed on an optical path of the light reflected by the reflection unit 20, and may allow the light incident to the lens unit 30 to be emitted outwardly from the light emitting module 100. For example, the lens unit 30 may include an aspheric lens or a spherical lens. In the present exemplary embodiment, the lens unit 30 may have a focal plane (S) of which the center on an optical axis p of the lens unit 30 is convex toward the reflection unit 20.

In addition, the light emitting module 100 in the present exemplary embodiment may further include the housing 40 accommodating the light emitting unit 10 and the reflection unit 20. In this case, the lens unit 30 may be fixed to the housing 40. In some cases, an inner wall of the housing 40 may be provided as a reflective surface so as to allow the light generated in the light emitting unit 10 to be effectively emitted externally through the lens unit 30. The housing 40 may be formed of a material having high heat conductivity and high rigidity, without being limited thereto. For example, a metal material such as aluminum, a heat-dissipating resin, or the like may be used therefor.

The light emitting unit 10 may include a board 11 and the plurality of light sources 12. The board 11 may be a circuit board commonly used in the art, such as a printed circuit board (PCB), a metal core printed circuit board (MCPCB), a metal printed circuit board (MPCB), a flexible printed circuit board (FPCB), or the like, and may include wiring patterns on the surface and the interior thereof, wherein the wiring patterns may be electrically connected to the plurality of light sources 12. As illustrated in FIGS. 1 and 2, the board 11 may have a flat mounting surface F which is perpendicular to the optical axis p of the lens unit 30, and the plurality of light sources 12 may be disposed on the mounting surface F.

Any device able to emit light may be used as the light source 12. For example, each of the plurality of light sources 12 may be a semiconductor light emitting device or a light emitting device package having a semiconductor light emitting device. In the exemplary embodiment of FIG. 1, a single light source 12 is illustrated as being configured as a single light emitting device package. However, the light source configuration is not limited thereto. A single light source 12 may be configured to include a plurality of semiconductor light emitting devices or a plurality of light emitting device packages.

Light emitting surfaces of the plurality of light sources 12 may be disposed to be substantially equal level with each other on the basis of the mounting surface F of the board 11, but the disposition thereof is not limited thereto. The plurality of light sources 12 may be arranged on the mounting surface F in rows and columns. In the present exemplary embodiment, the plurality of light sources 12 may be arranged in three rows and nine columns in an x-axis direction and a y-axis direction perpendicular to the optical axis p of the lens unit 30. However, the number of rows and columns may be varied.

The reflection unit 20 may be disposed on the light emitting unit 10 to reflect light emitted from the light emitting unit 10. More specifically, the reflection unit 20 in the present exemplary embodiment may have a first surface 1 adjacent to the mounting surface F of the board 11 of the light emitting unit 10, a second surface 2 adjacent to the lens unit 30, and a plurality of reflection holes H penetrating through the first and second surfaces 1 and 2. The plurality of reflection holes H may correspond to the plurality of light sources 12 disposed on the light emitting unit 10, respectively, and inner walls Hs thereof may be provided as reflective surfaces to reflect the light emitted from the plurality of light sources 12 to the lens unit 30.

The plurality of reflection holes H may have different depths. A depth of a reflection hole distant from the optical axis p of the lens unit 30 may be greater than a depth of a reflection hole adjacent to the optical axis p of the lens unit 30. For example, the depths of the plurality of reflection holes H may be increased as distances L1 thereof from the optical axis p of the lens unit 30 in a direction perpendicular to the optical axis p of the lens unit 30 are increased. Specifically, as illustrated in FIG. 2, the reflection holes H of the reflection unit 20 may be formed to have a structure in which a depth t1 of a reflection hole farthest away from the optical axis p of the lens unit 30 in the direction perpendicular to the optical axis p of the lens unit 30, that is, in the x-axis direction is greater than a depth t2 of a reflection hole positioned on the optical axis p.

In this case, the plurality of reflection holes of the reflection unit 20 may be provided with a plurality of openings, wherein each reflection hole H may be provided with a first opening Ha and a second opening Hb facing the first opening Ha. The first opening Ha may be parallel to the second opening Hb. Here, the plurality of first openings Ha may be disposed to be adjacent to the light emitting unit 10, and the plurality of second openings Hb may be disposed to be adjacent to the lens unit 30. Distances of the plurality of second openings Hb from the lens unit 30 may be decreased as the distances thereof from the optical axis p of the lens unit 30 in the direction perpendicular to the optical axis p of the lens unit 30 are increased.

The plurality of second openings Hb may be disposed on the second surface 2 of the reflection unit 20. In this case, the second surface 2 may have a stepped portion which is concave with respect to the focal plane S of the lens unit 30. More specifically, referring to FIG. 2, the center of the focal plane S of the lens unit 30 on the optical axis p may be convex toward the reflection unit 20. Here, a second opening Hb farthest from the optical axis p of the lens unit 30 in the x-axis direction perpendicular to the optical axis p of the lens unit 30 may be positioned to be higher than a second opening Hb positioned on the optical axis p, and thus a distance d1 of the second opening Hb disposed at an end of the reflection unit 20 from the lens unit 30 may be less than a distance d2 of the second opening Hb disposed at the center of the reflection unit 20 from the lens unit 30. Accordingly, the second surface 2 provided with the plurality of second openings Hb may have the stepped portion which is downwardly depressed in a position corresponding to the optical axis p of the lens unit 30.

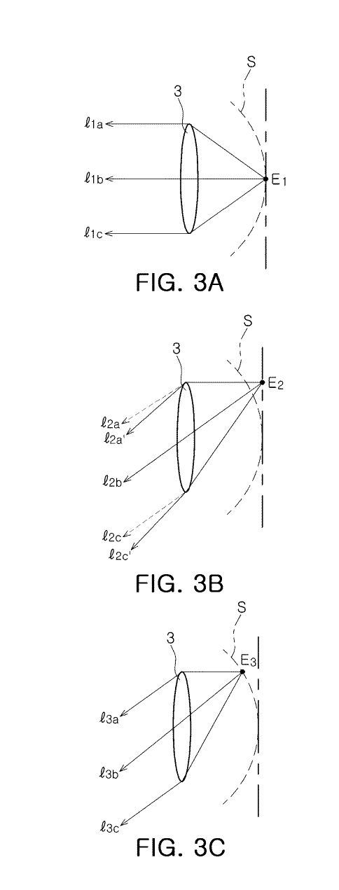

By employing the reflection unit 20 having the above-described structure, the light emitting module 100 in the present exemplary embodiment may obtain a reduction in spherical aberration caused by the lens unit 30 to produce light having excellent quality. A principle related to spherical aberration reduction will be described in detail with reference to FIGS. 3A through 3C.

FIGS. 3A through 3C are views illustrating a principle of improving the quality of light emitted from the light emitting module 100 according to an exemplary embodiment in the present inventive concept, each of which illustrates a path of light emitted from any light source E1, E2 or E3 and passing through a lens 3.

First of all, with reference to FIG. 3A, in a case in which the lens 3 is disposed to be spaced apart from the light source E1 by a focal distance, light emitted from the light source E1 passes through the lens 3 to form a parallel pencil of rays l₁ₐ, l_{1b}, and l_{1c}. In a case in which the light source E2 is moved upwardly as illustrated in FIG. 3B, ideally, the light passing through the lens 3 should form a parallel pencil of rays as indicated by dotted lines l₂ₐ, l_{2b}, and l_{2c}, but here, in actuality, the light may form a non-parallel pencil of rays each other, as indicated by solid lines l_{2a′}, l_{2b}, and l_{2c′}, due to a distance between the light source E2 and a focal plane S of the lens 3. Therefore, in a case in which the plurality of light sources of the light emitting module are disposed on a plane perpendicular to the optical axis of the lens, light emitted from each of the plurality of light sources fails to form a parallel pencil of rays due to physical properties of the lens such as spherical aberration or the like, and in this case, a light distribution area of the light emitting module may not have a clearly-defined boundary.

On the other hand, the light source E3 is moved toward the lens 3 as illustrated in FIG. 3C, a distance between the light source E3 and the focal plane S of the lens 3 may be compensated for, the light emitted from the light source E3 may pass through the lens 3 to forma substantially parallel pencil of rays l₃ₐ, l_{3b}, and l_{3c}.

Based on the above premise, with reference to FIG. 2, the light emitting module 100 according to the present exemplary embodiment may include the plurality of reflection holes H corresponding to the plurality of light sources 12, respectively, and as the depths (see t1 and t2) of the plurality of reflection holes H may be increased as the distances L1 thereof from the optical axis p of the lens unit 30 in the direction perpendicular to the optical axis p of the lens unit 30 are increased.

That is, since the plurality of light sources 12 are disposed on the flat mounting surface F of the board 11 perpendicular to the optical axis p of the lens unit 30, the distances thereof from the focal plane S of the lens unit 30 may be increased as the distances L1 thereof from the optical axis p of the lens unit 30 in the direction perpendicular to the optical axis p of the lens unit 30 are increased. However, the reflection unit 20 may have a structure in which distances (see d1 and d2) between the second openings Hb and the lens unit 30 may be decreased as the distances L1 of the second openings Hb of the plurality of reflection holes from the optical axis p of the lens unit 30 in the direction perpendicular to the optical axis p are increased, and thus distances between the light sources 12 and the focal plane S may be compensated for. Therefore, the light emitting module 100 according to the present exemplary embodiment may have substantially the same effect as that of a case in which the plurality of light sources arranged on the flat surface of the board were to be disposed to have different mounting heights, and thus it may produce light having excellent quality in which the spherical aberration caused by the lens unit 30 is reduced.

To this end, sizes of the plurality of second openings Hb may be similar to each other. The sizes of the openings are not particularly limited, and for example, the plurality of second openings Hb may have substantially the same size. Likewise, the plurality of first openings Ha may have substantially the same size. In this case, as illustrated in FIG. 2, inclination of the plurality of inner walls Hs provided as the reflective surfaces of the plurality of reflection holes H may be increased as the distances L1 of the plurality of reflection holes H from the optical axis p of the lens unit 30 in the direction perpendicular to the optical axis p are increased.

In addition, in the light emitting module 100 according to the exemplary embodiment in the present inventive concept, the mounting surface F of the board 11 on which the light sources 12 are disposed may be provided as a flat surface, without being provided as a spherical surface or having a stepped portion. Therefore, the manufacturing of the board 11 may be facilitated and convenience in mounting the light sources 12 on the mounting surface F may be increased.

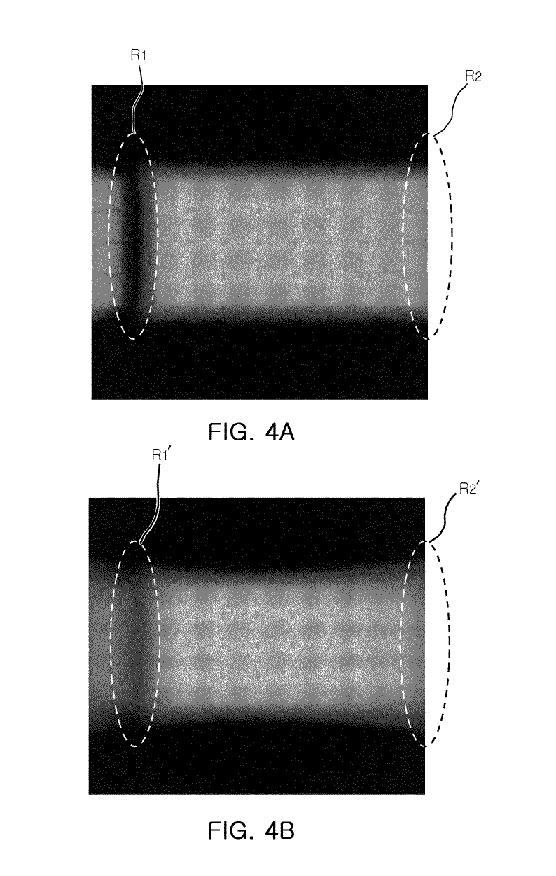

FIGS. 4A and 4B are photographs illustrating the effect of a light emitting module according to an exemplary embodiment in the present inventive concept. FIG. 4A is a photograph illustrating a light distribution area of a light emitting module according to an inventive example, and FIG. 4B is a photograph illustrating a light distribution area of a light emitting module according to a comparative example. Although not illustrated, the light emitting module according to the comparative example includes a plurality of light sources disposed on a flat surface of a board and a reflection unit having a uniform height. With reference to FIGS. 4A and 4B, it can be seen that the light distribution area of the light emitting module according to the exemplary embodiment in the present inventive concept has a clearly-defined boundary, and reduced spherical aberration (see R1 and R2 of FIG. 4A and R1′ and R2′ of FIG. 4B).

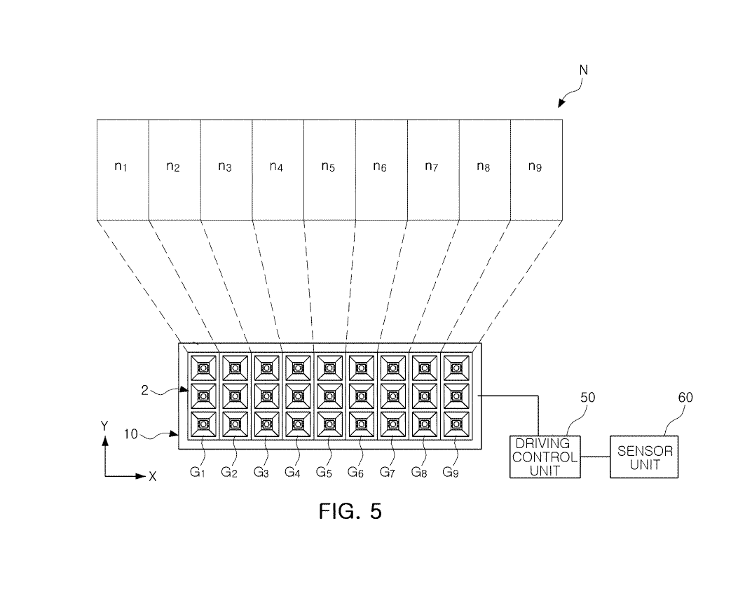

FIG. 5 is a view illustrating a modified exemplary embodiment of FIG. 1, in which the light emitting unit 10 and the reflection unit 20 of the light emitting module 100 are viewed from above.

Referring to FIG. 5, the plurality of light sources 12 may include first to n-th light source groups sequentially arranged in the direction perpendicular to the optical axis p of the lens unit 30, where n is an integer equal to or greater than 2.

FIG. 5 also illustrates a light distribution area N formed by the light emitted from the light emitting module 100, and the light distribution area N is divided into first to n-th division areas corresponding to the first to n-th light source groups, respectively. For example, the plurality of light sources 12 may be divided into first to ninth light source groups G₁ to G₉ from the left to the right on the x-axis, and the light distribution area N formed by the light emitted from the light emitting module 100 may be divided into first to ninth division areas n₁ to n₉ corresponding to the first to ninth light source groups G₁ to G₉, respectively.

In the present exemplary embodiment, the light emitting module 100 may include a driving control unit 50 supplying driving power to the plurality of light sources 12. The driving control unit 50 may control the driving of each of the first to n-th light source groups.

Accordingly, the light emitting module 100 may enable divided driving control in a manner in which light may be irradiated into particular division areas corresponding to respective light source groups or may not be irradiated thereinto.

In order to enable excellent divided driving control, the boundary of the light distribution area N needs to be clearly defined. In the present exemplary embodiment, the divided driving control may be largely achieved due to a reduction in spherical aberration. For example, a problem in which light emitted from the first light source group G₁ and the third light source group G₃ reaches the second division area n₂ due to spherical aberration may be reduced, and thus, if the second light source group G₂ is turned off in order to allow the second division area n₂ of the light distribution area N to not be irradiated with light, a boundary between the second division area n₂ and the first division area n₁ or a boundary between the second division area n₂ and the third division area n₃ is clearly defined, whereby the divided driving control may be enabled. In particular, an influence of the spherical aberration of the lens is increased toward an edge portion of the light distribution area N. In the present exemplary embodiment, the boundaries between the division areas are further clearly defined at the left side of the first division area n₁ and the right side of the ninth division area n₉.

In the present exemplary embodiment, the light emitting module 100 may further include a sensor unit 60. The sensor unit 60 may include, for example, at least one of a position sensor detecting the position of an object and a light receiving sensor detecting external light. In this case, the driving control unit 50 may determine whether to drive the first to n-th light source groups in order to allow light to not be irradiated into a particular division area or to only be irradiated into a particular division area according to a sensing signal generated by the sensor unit 60.

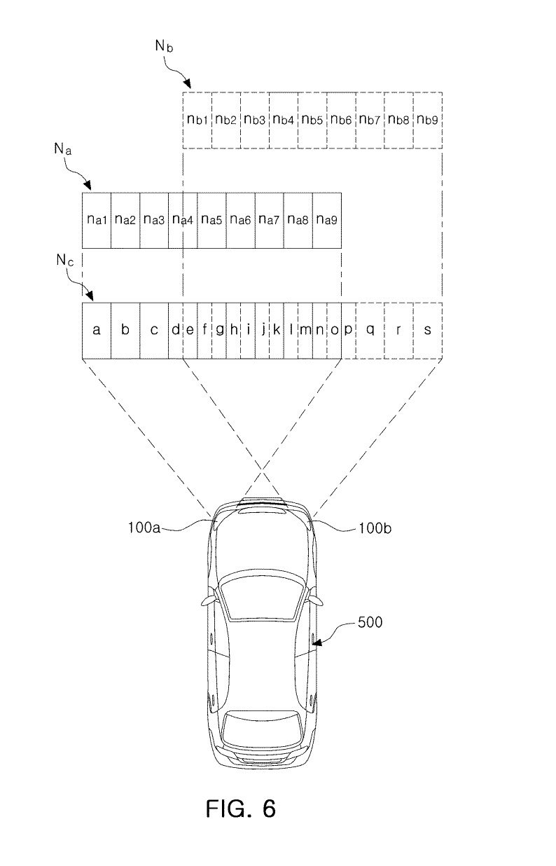

Hereinafter, a case of configuring a headlight module using the light emitting module 100 according to the exemplary embodiment in the present inventive concept will be described with reference to FIGS. 6 through 9B.

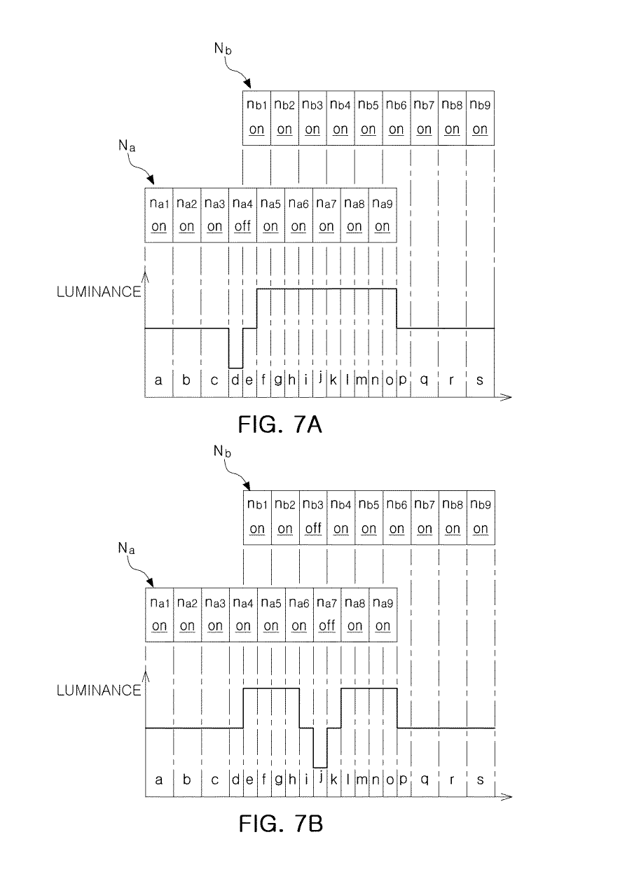

FIG. 6 is a conceptual view illustrating an example of a headlight module to which the light emitting module according to the present exemplary embodiment is applied, and FIGS. 7A and 7B are conceptual views illustrating the operations of the headlight module.

With reference to FIG. 6, the headlight module may include a first light emitting module 100a positioned on the left side of the front of a vehicle 500 and a second light emitting module 100b positioned on the right side of the front of the vehicle 500.

In the present exemplary embodiment, first to ninth light source groups of the first light emitting module 100a may be individually controlled by a driving control unit 50, and thus, a light distribution area Na formed by light emitted from the first light emitting module 100a may be divided into first to ninth division areas nₐ₁ to nₐ₉ that may be dividedly controlled. Likewise, a light distribution area Nb formed by light emitted from the second light emitting module 100b may also be divided into first to ninth division areas n_{b1} to n_{b9}.

At least a portion of the first to ninth division areas nₐ₁ to nₐ₉ associated with the first light emitting module 100a and at least a portion of the first to ninth division areas n_{b1} to n_{b9} associated with the second light emitting module 100b may be overlapped. Accordingly, a light distribution area Nc of the headlight module according to the present exemplary embodiment may be divided into 19 division areas a to s as illustrated in FIG. 6, and divided driving control may be enabled in a way by allowing light to not be irradiated into a particular division area or to only be irradiated into a particular division area.

For example, as illustrated in FIG. 7A, while all the light source groups of the second light emitting module 100b are turned on, in a case in which the light source groups of the first light emitting module 100a except for the fourth light source group are turned on, the light is not irradiated into a division area d in the light distribution area Nc of the headlight module. Similarly, as illustrated in FIG. 7B, in a case in which the light source groups of the first light emitting module 100a except for the seventh light source group are turned on and the light source groups of the second light emitting module 100b except for the third light source group are turned on, the light is not irradiated into a division area j in the light distribution area Nc of the headlight module.

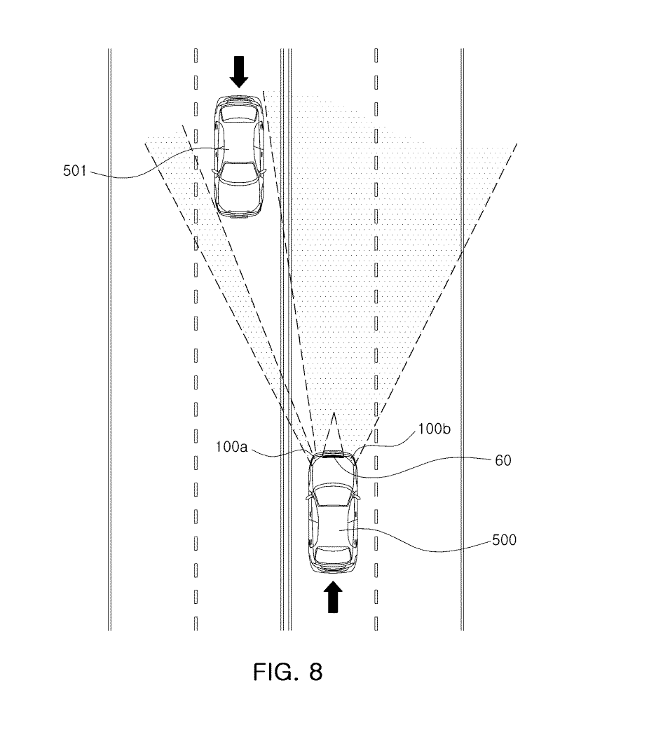

Therefore, in the case of using the headlight module according to the present exemplary embodiment, as illustrated in FIG. 8, the headlight module may be controlled to allow a particular division area corresponding to the position of an oncoming vehicle 501 to not be irradiated with light, so that the view of a driver of a traveling vehicle 500 may be maximally secured while the view of a driver of the oncoming vehicle 501 may not be obscured, whereby safe driving may be promoted.

In the present exemplary embodiment, at least one of the first and second light emitting modules 100a and 100b may include the sensor unit 60, wherein the sensor unit 60 may include at least one of a position sensor and a light receiving sensor so as to detect the position of the oncoming car 501. The light receiving sensor may detect light emitted from a headlight module of the oncoming car 501 to determine the position of the oncoming car 501.

In the case of employing the light emitting module according to the present exemplary embodiment, boundaries between the division areas may be clearly defined, whereby better divided driving control may be enabled.

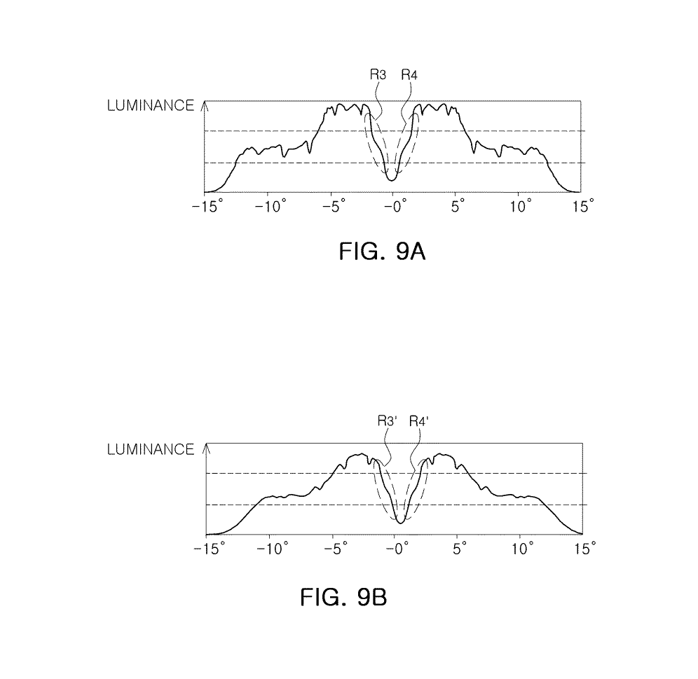

FIGS. 9A and 9B are graphs illustrating comparative experimental results to illustrate the effect of the headlight module according to the exemplary embodiment of FIG. 6.

FIG. 9A illustrates the results in a case in which the headlight module is configured using a light emitting module according to an inventive example, and FIG. 9B illustrates the results in a case in which the headlight module is configured using a light emitting module according to a comparative example. The structure of the light emitting module according to the comparative example is not illustrated, but it includes a plurality of light sources disposed on a flat surface of aboard and a reflection unit having a uniform height. With reference to FIGS. 9A and 9B, it can be seen that the inclination of an area indicated by R3 and R4 of FIG. 9A is greater than that of an area indicated by R3′ and R4′ of FIG. 9B. That is, it can be appreciated that in the headlight module according to the exemplary embodiment in the present inventive concept, a boundary between a division area which is set to not be irradiated with light and a division area which is set to be irradiated with light may be further clearly defined.

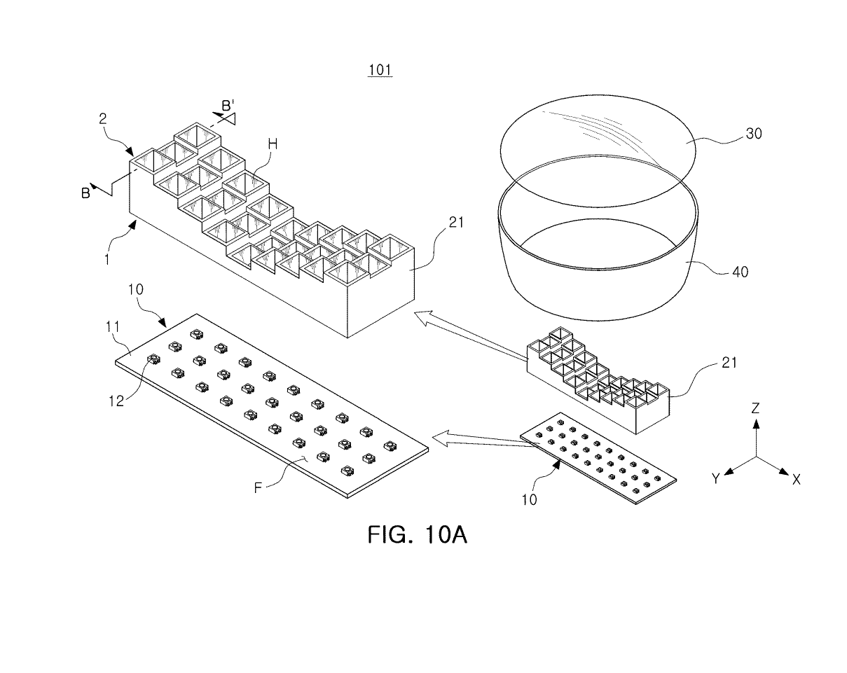

FIG. 10A is an exploded perspective view schematically illustrating a light emitting module 101 according to an exemplary embodiment in the present inventive concept, and FIG. 10B is a cross-sectional view of FIG. 10A, taken along line B-B′.

Hereinafter, a description of features the same as those described above with reference to FIG. 1 will be omitted, and a description of different features will be detailed.

With reference to FIGS. 10A and 10B, the light emitting module 101 according to this exemplary embodiment in the present inventive concept may include a light emitting unit 10, a reflection unit 21 and a lens unit 30. Depths of a plurality of reflection holes H included in the reflection unit 21 may be increased as distances thereof from an optical axis p of the lens unit 30 in a direction perpendicular to the optical axis p of the lens unit 30 are increased. Here, the direction perpendicular to the optical axis p of the lens unit 30 may include a first direction and a second direction. The directions are not limited thereto, but the second direction may refer to a direction perpendicular to the optical axis p and the first direction.

More specifically, as illustrated in FIG. 10A, the depths of the plurality of reflection holes H may be increased as distances thereof from the optical axis p based on an x-axis perpendicular to the optical axis p are increased. In addition, as illustrated in FIGS. 10A and 10B, depths (see t1 and t3) of the plurality of reflection holes H may be increased as distances L2 thereof from the optical axis p based on a y-axis perpendicular to the optical axis p and the x-axis are increased. Since the light emitting module 101 according to the present exemplary embodiment employs the structure of the reflection unit 21 for reducing spherical aberration in both the x-axis and y-axis directions, it may produce light having better quality as compared with the light emitting module 100 of FIG. 1.

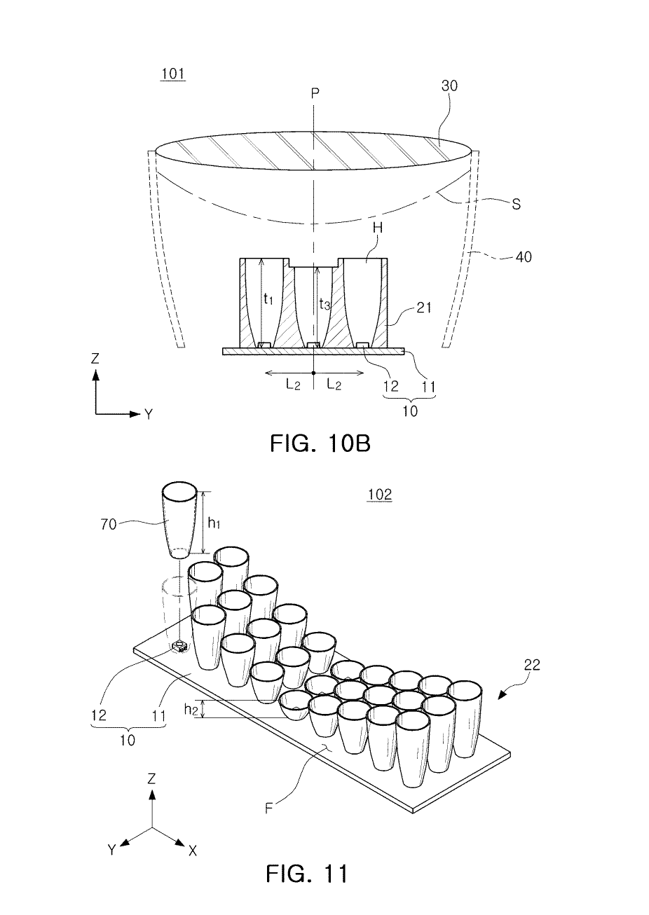

Meanwhile, the reflection unit according to the present exemplary embodiment does not need to be formed as a single element, and may include a plurality of reflective optical elements 70 as illustrated in FIG. 11.

FIG. 11 is a perspective view schematically illustrating a light emitting unit 10 and a reflection unit 22 applicable to a light emitting module 102 according to an exemplary embodiment in the present inventive concept.

With reference to FIG. 11, the reflection unit 22 may include the plurality of reflective optical elements 70. The plurality of reflective optical elements 70 may be disposed to correspond to the plurality of light sources 12 included in the light emitting unit 10, respectively, and may include reflective cups having internal reflective surfaces, respectively.

Heights (see h1 and h2) of the plurality of reflective optical elements 70 may be increased as distances thereof from an optical axis P of a lens unit 30 in a direction perpendicular to the optical axis of the lens unit 30 are increased. That is, according to the present exemplary embodiment, the plurality of reflection holes may be provided by using the reflective cups provided in the plurality of reflective optical elements 70, respectively.

According to the present exemplary embodiment, the light emitting module 102 may produce light having excellent quality due to a reduction in spherical aberration caused by the lens unit. Furthermore, since the plurality of light sources 12 are disposed on a flat mounting surface F of a board 11, manufacturing the board 11 and arranging the light sources 12 on the board 11 may be facilitated.

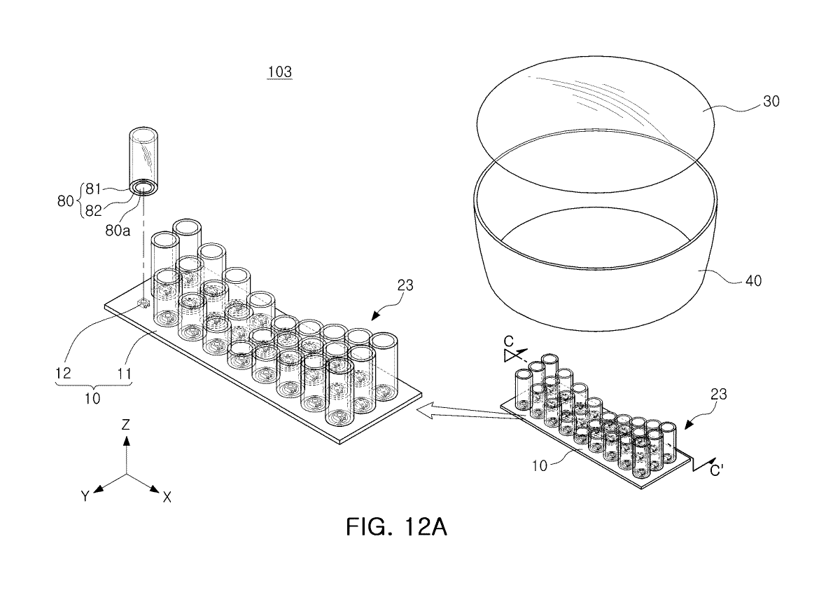

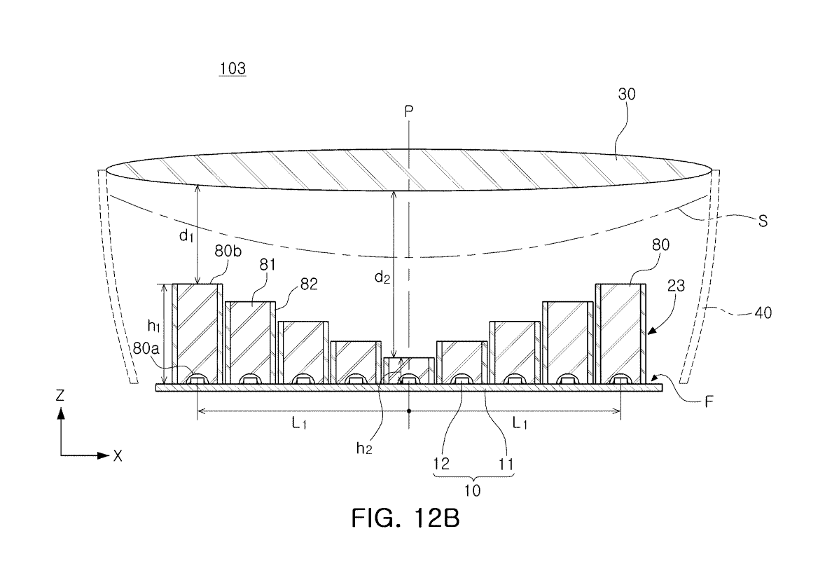

FIG. 12A is an exploded perspective view schematically illustrating a light emitting module 103 according to an exemplary embodiment in the present inventive concept, and FIG. 12B is a cross-sectional view of FIG. 12A, taken along line C-C′.

With reference to FIGS. 12A and 12B, the light emitting module 103 according to this exemplary embodiment in the present inventive concept may include a light emitting unit 10 including a plurality of light sources 12, a lens unit 30 and a plurality of light guides 80 disposed to correspond to the plurality of light sources 12, respectively, and guiding light emitted from the light sources 12 toward the lens unit 30. Similar to the reflection unit 20 illustrated in FIGS. 1 and 2, the reflection unit 21 illustrated in FIGS. 10A and 10B, and the optical element 70 illustrated in FIG. 11, the plurality of light guides 80 confine light emitted from the plurality of light sources. For example, the plurality of light guides 80 may each include a core 81 and a cladding surrounding the core 81, and the core 81 and the cladding 82 may have different refractive indexes so that light may be totally reflected at a boundary therebetween. For example, the reflective index of the core 81 may be higher than that of the cladding 82.

The plurality of light guides 80 may each include a light incidence surface 80a to which light emitted from the corresponding light source 12 is incident and a light emitting surface 80b from which the light incident through the light incidence surface 80a is emitted. In this exemplary embodiment, the lens unit 30 may be disposed on an optical path of the light emitted through the light emitting surface 80b. The light emitting surface 80b may be a convex surface protruding in a direction (z-axis direction) parallel to the optical axis p of the lens unit 30, and accordingly, the light emitted from each of the light sources 12 may be effectively distributed. The light incidence surface 80a may include a concave recess so as to accommodate the corresponding light source 12. In addition, the light emitting surfaces 80b of the plurality of light guides 80 may have substantially the same size.

The light emitting module 103 may further include a housing 40 accommodating the light emitting unit 10 and the plurality of light guides 80.

In the present exemplary embodiment, distances between the lens unit 30 and the light emitting surfaces of the plurality of light guides 80 may be varied. Specifically, a distance between the lens unit 30 and a light emitting surface of a light guide distant from the optical axis p of the lens unit 30 may be less than a distance between the lens unit 30 and a light emitting surface of a light guide adjacent to the optical axis p of the lens unit 30. For example, distances (see d1 and d2) between the light emitting surfaces 80b of the plurality of light guides 80 and the lens unit 30 may be decreased as distances L1 of the plurality of light guides 80 from the optical axis p of the lens unit 30 in a direction perpendicular to the optical axis p of the lens unit 30 are increased. To this end, heights (see h1 and h2) of the plurality of light guides 80 may be increased as the distances L1 thereof from the optical axis p of the lens unit 30 in the direction perpendicular to the optical axis p of the lens unit 30 are increased. That is, the light emitting module 103 according to the present exemplary embodiment may be configured by employing the plurality of light guides 80 replacing the reflection unit 20 of FIG. 1 having the plurality of reflection holes H. According to the present exemplary embodiment, the light emitting module 103 may produce light having excellent quality by reducing the spherical aberration caused by the lens.

As set forth above, according to exemplary embodiments in the present inventive concept, a light emitting module can produce light having excellent quality due to a reduction in spherical aberration of a lens.

In addition, a particular area in a light distribution area of the light emitting module is not irradiated with light through divided driving control of the light emitting module. In this case, the division of the light distribution area may be controlled properly due to the reduced spherical aberration.

While exemplary embodiments have been shown and described above, it will be apparent to those skilled in the art that modifications and variations could be made without departing from the scope of the present invention as defined by the appended claims.

What is claimed is:

1. A light emitting module, comprising:
a light emitting unit including a plurality of light sources;
a reflection unit disposed on the light emitting unit and reflecting light emitted from the light emitting unit; and
a lens unit disposed on an optical path of the light reflected by the reflection unit,
wherein the reflection unit includes a plurality of reflection holes corresponding to the plurality of light sources and having inner walls which are provided as reflective surfaces, and
wherein a depth of a reflection hole distant from an optical axis of the lens unit is greater than a depth of a reflection hole adjacent to the optical axis of the lens unit.

2. The light emitting module of claim 1, wherein depths of the plurality of reflection holes are increased as distances thereof from the optical axis of the lens unit in a direction perpendicular to the optical axis of the lens unit are increased.

3. The light emitting module of claim 1, wherein the light emitting unit includes a board having a flat mounting surface perpendicular to the optical axis of the lens unit, and
light emitting surfaces of the plurality of light sources are disposed to be substantially equal level with each other based on the mounting surface of the board.

4. The light emitting module of claim 1, wherein the plurality of reflection holes include first openings adjacent to the light emitting unit and second openings adjacent to the lens unit, respectively, and
distances of the second openings from the lens unit are decreased as distances of the second openings from the optical axis of the lens unit in a direction perpendicular to the optical axis of the lens unit are increased.

5. The light emitting module of claim 4, wherein the reflection unit has a first surface on which the first openings are disposed and which is provided as a flat surface perpendicular to the optical axis of the lens unit, and a second surface on which the second openings are disposed and which is stepped.

6. The light emitting module of claim 5, wherein the lens unit has a focal plane of which the center on the optical axis is convex toward the reflection unit, and
the second surface of the reflection unit has a stepped portion which is concave with respect to the focal plane.

7. The light emitting module of claim 4, wherein the second openings have substantially the same size.

8. The light emitting module of claim 4, wherein the inner walls extend from the first openings to the second openings with a predetermined degree of inclination, and
the degree of inclination is increased as distances of the inner walls from the optical axis of the lens unit in the direction perpendicular to the optical axis are increased.

9. The light emitting module of claim 1, wherein the depths of the plurality of reflection holes are increased as distances thereof from the optical axis of the lens unit in at least one of first and second directions are increased, and wherein a first direction is perpendicular to the optical axis of the lens unit and a second direction is perpendicular to the optical axis and the first direction.

10. The light emitting module of claim 1, wherein the reflection unit includes a plurality of reflective optical elements having reflective cups, respectively, and
the plurality of reflection holes are provided by using the reflective cups included in the reflective optical elements.

11. The light emitting module of claim 1, further comprising a driving control unit configured to supply driving power to the plurality of light sources,
wherein the plurality of light sources are divided into first to n-th light source groups sequentially arranged in a direction perpendicular to the optical axis of the lens unit, where n is an integer equal to or greater than 2, and
the driving control unit is configured to individually control the first to n-th light source groups.

12. The light emitting module of claim 11, further comprising a sensor unit configured to generate a sensing signal by detecting at least one of a position of an object and external light,
wherein the driving control unit determines whether to drive the first to n-th light source groups according to the sensing signal generated by the sensor unit.

13. A light emitting module, comprising:
a light emitting unit including a plurality of light sources;
a plurality of light guides disposed to correspond to the plurality of light sources, respectively, each of which has a light incidence surface to which light emitted from a corresponding light source is incident and a light emitting surface from which the light incident through the light incidence surface is emitted; and
a lens unit disposed on an optical path of the light emitted through the light emitting surfaces of the plurality of light guides,
wherein a distance between the lens unit and a light emitting surface of a light guide distant from an optical axis of the lens unit is less than a distance between the lens unit and a light emitting surface of a light guide adjacent to the optical axis of the lens unit.

14. The light emitting module of claim 13, wherein distances between the lens unit and the light emitting surfaces of the plurality of light guides are decreased as distances of the plurality of light guides from the optical axis of the lens unit in a direction perpendicular to the optical axis of the lens unit are increased.

15. The light emitting module of claim 13, wherein heights of the plurality of light guides are increased as distances of the plurality of light guides from the optical axis of the lens unit in a direction perpendicular to the optical axis of the lens unit are increased.

16. A light emitting module, comprising:
a lens unit having an optical axis;
a plurality of light sources disposed spaced-apart from the lens unit; and
a plurality of light confining units disposed between the plurality of light sources and the lens unit, each light confining unit corresponding to one of the plurality of light sources and guiding light emitted from the one of the plurality of light sources to the lens unit,
wherein a distance between the lens unit and a light confining unit distant from the optical axis of the lens unit is less than a distance between the lens unit and a light confining unit adjacent to the optical axis of the lens unit.

17. The light emitting module of claim 16, wherein the plurality of light sources are disposed at a plane perpendicular to the optical axis of the lens unit.

18. The light emitting module of claim 16, wherein lengths of the light confining units are increased as distances thereof from the optical axis of the lens unit in a direction perpendicular to the optical axis of the lens unit are increased.

19. The light emitting module of claim 16, wherein each light confining unit includes a hole confined by a reflective inner wall of said each light confining unit,
the hole of said each light confining unit extends from a corresponding light source of said each light confining unit toward the lens unit in a direction parallel to the optical axis of the lens unit, and
the plurality of light confining units are integrally formed as a single element or formed as discrete elements.

20. The light emitting module of claim 16, wherein each light confining unit includes a core extending from a corresponding light source of said each light confining unit toward the lens unit in a direction parallel to the optical axis of the lens unit, and a cladding surrounding the core, and
the core and the cladding have different refractive indexes.
